(19) United States
(12) Patent Application Publication
(10) Pub. No.: US 2015/0038221 A1
(43) Pub. Date: Feb. 5, 2015

(54) Gaming device and online wagering game bonus entry system

(71) Applicant: Steven Brandstetter, Dix Hills, NY (US)

(72) Inventor: Steven Brandstetter, Dix Hills, NY (US)

(73) Assignee: MGT GAMING, INC.

(21) Appl. No.: 13/987,484

(22) Filed: Jul. 30, 2013

(51) Int. Cl. G07F 17/32

(52) U.S. Cl. CPC G07F 17/3258
USPC 463/27; 463/25

(57) ABSTRACT

A gaming system for entry into a progressive bonus from the play of a gaming device or from the play of an online wagering game via the Internet. The gaming system further allows for a drawing ticket for the entry into a drawing or tournament entry based on the play of either a gaming device or an online wagering game.

### FIELD OF THE INVENTION

A gaming machine system wherein a progressive bonus can be won from any one of a plurality of gaming devices and online wagering games. The gaming machine system further provides for a drawing ticket for entry into a drawing for cash or prizes. The gaming machine system further provides for entry into a tournament played from any of the gaming devices and online wagering games connected to the system.

### BACKGROUND OF THE INVENTION

The casino industry in the United States is a highly competitive industry that offers entertainment to people who enjoy playing traditional casino games such as slot machines and table games in a traditional casino environment. New competition to the traditional casino is coming in the near future because of the recently passed and future legislation to allow the play of online casino and lottery games. The present invention creates a gaming machine system to play the traditional gaming devices connected with the play of the online wagering games to offer bonus jackpots, as well as entry into drawings and tournament type games.

U.S. Pat. No. 7,387,571 relates to a method and apparatus for providing linked play via gaming and other devices. In some embodiments, a casino server registers a group for linked play and a group objective and format are established. The linked play commences according to the group format on the gaming devices while the casino server, or another device, concurrently facilitates interaction between the group members operating the gaming devices. The linked play is terminated according to the group format and a determination is made by the casino server whether the group objective has been achieved. Prizes are awarded via the gaming devices if the group objective was achieved.

U.S. Pat. No. 7,871,323 relates to a method for providing entry into a bonus game at a gaming device, where the bonus games may occur at predictable times and may payout predictable amounts. A gaming device may provide a guaranteed entry into a bonus game every hour on the hour, so long as a player meets one or more criteria. Criteria may include a total amount wagered, a total number of handle pulls completed, or a total amount of time spent at a gaming device. A method provides for withholding value from a player in order that the value may delivered later in the form of a guaranteed entry into a bonus game. Multiple gaming devices may provide entry in bonus rounds simultaneously, thereby creating mutually reinforcing sounds and visual displays.

U.S. Pat. No. 7,901,294 relates to a method of controlling a plurality of gaming devices in a gaming network, comprising: configuring each of a plurality of separate gaming devices to accept control from a first gaming device, the first gaming device being distinct from any of the plurality of separate gaming devices; causing the first gaming device to provide any first award based on a first play of a first game; causing the first gaming device to send a control signal to at least one of the separate gaming devices, the control signal causing at least one of the separate gaming devices to provide any second award based on a first play of a second game; determining any third award based on at least one element of the first play of the first game of the first gaming device and at least one element of the first play of the second game of the separate gaming device; and causing the first gaming device to provide any third award.

U.S. Pat. No. 8,047,909 relates to a system and method for providing linked play via gaming and other devices wherein players may share and combine outcomes or parts thereof. In some embodiments, a casino server registers a group for linked play and a group objective and format are established. The linked play commences according to the group format on the gaming devices while the casino server, or another device, concurrently facilitates interaction between the group members operating the gaming devices. During the interaction, players may combine outcomes in an attempt to win group prizes. The linked play is terminated according to the group format and a determination is made by the casino server whether the group objective has been achieved. Prizes are awarded via the gaming devices if the group objective was achieved

U.S. Pat. No. 8,113,946 relates to a method for providing payments at a gaming device, where the payments may occur at predictable times and are of predictable amounts. A gaming device may provide a guaranteed payment every hour on the hour, so long as a player meets one or more criteria. Criteria may include a total amount wagered, a total number of handle pulls completed, or a total amount of time spent at a gaming device. A method provides for withholding value from a player in order that the value may delivered later in the form of a guaranteed payment. Multiple gaming devices may provide payments simultaneously, thereby creating mutually reinforcing sounds and visual displays.

U.S. Pat. No. 8,147,322 relates to a plurality of gaming devices linked so as to effectuate multiplayer game play. Multiplayer game play may cost more than single player game play, but may provide bonus payouts in the multiplayer game play. Various embodiments disclose symbol swapping, best ball, and match multiplayer game play.

U.S. Pat. No. 8,342,949 relates to a gaming system operable to determine a first gaming device being operated by a player and select a second gaming device to be controlled, via the first gaming device, by the player. The gaming system is further operable to configure the second gaming device to be controlled via an interface of the first gaming device.

U.S. Pat. Application No. 20120123570 relates to a wagering game system and its operations. The operations can include generating game history for each of a plurality of wagering games, associated with a first wagering game title, played by a first player via a wagering game system. The operations can also include randomly selecting, from the game history, a subset of the plurality of wagering games previously played by the first player, and generating a computer bot for the first player, based on the subset of the plurality of wagering games, to be used during a multiplayer wagering game competition to play for the first player. The operations can further include initiating, via the wagering game system, the multiplayer wagering game competition, replaying, during the multiplayer wagering game competition, the subset of the plurality of wagering games using the computer bot, and determining results of the multiplayer wagering game competition.

### SUMMARY OF THE INVENTION

The present invention relates to gaming systems that comprise traditional gaming devices such as slot machines, VLT's, video poker games, etc. found in a casino environment connected to the play of online wagering games that are played via the Internet. By connecting the play of the casino gaming devices to the online wagering games, the operator can offer significantly higher jackpots because the jackpots can be financed from a larger pool of money being wagered. Larger jackpots have traditionally been associated with increased play.

It is an object of the present invention to offer drawings and tournaments with bigger jackpots and prizes because of the larger pool of players playing within the gaming system.

It is an object of the present invention for the gaming system to have a connectable device that has access to all of the information of the plurality of gaming devices and online wagering games on the system.

It is an object of the present invention for the connectable device to be controlled by a computer program that utilizes the Internet or other network infrastructure to communicate with any of the plurality of gaming devices and online wagering games.

It is an object of the present invention for the information to be transferred via a wired or wireless network that uses the Internet or other means and can be stored in a cloud or by other methods.

It is an object of the present invention to have the amount of the progressive bonus be shown on all of the gaming devices and on all of the online wagering games that are connected to the system and that the progressive bonus will increment higher as the games are being played.

It is an object of the present invention to have a system that alerts a player when they have won the progressive bonus. It is an object of the present invention for the progressive bonus prize to be generated from a percentage of the total money wagered into all games which are part of the gaming system.

It is an object of the present invention for players to join together and play as a group. The group can elect to share the progressive bonus. If any member of the group wins the progressive bonus on their gaming device or online wagering game, then each group member wins a share of the progressive bonus. For example; if the progressive bonus amount is $1,000,000 and five players have elected to join together and play as a group, then if any group member hits the progressive bonus, then all five members will share the progressive bonus equally and each wins $200,000.

It is an object of the present invention for the system to increase the progressive bonus at off hours to increase play. The system can choose a day of the week and increase the progressive bonus to increase play on that day. For example; if the operator decides that very few players play between 1:00 AM and 5:00 AM on Tuesdays then the operator of the gaming system can change the progressive bonus amount to a higher amount during those times to entice more players to play at those hours.

It is an object of the present invention for the system to increase the drawing jackpot for long term or loyal play. It is a further object of the present invention for the system to give extra drawing tickets based on time played, amount wagered, or consistent play on a regular basis.

It is an object of the present invention for the system to offer the players of the online wagering games an extra bonus such as an entry in a drawing or an entry into a tournament if the player comes to the casino. It is a further object of the present invention for the system to offer the gaming device players in the casino an extra bonus if they continue to play online. The extra bonus could be cash or prizes or an offer of a drawing ticket or entry into a tournament.

It is an object of the present invention for the system to send messages or promotional advertising to both the gaming device player and the online wagering game player. It is an object of the present invention for all players within the gaming system to communicate with each other.

It is an object of the present invention for the gaming devices and online wagering games to have the correct mechanism for a player to operate the tournament event from any of the gaming devices or online wagering games. The tournament can be played at the gaming devices in the casino environment and played online by the players who played the online wagering games.

It is an object of the present invention for the gaming devices to have a video recorder to record a picture or video of the player while they are playing in a tournament. It is an object of the present invention for the players of the online wagering devices to use their computer video recorder or mobile device recorder to capture a picture or video of themselves while playing and have that video transferred to the system. It is an object of the present invention for the gaming system to transmit all of the players pictures or videos so that the images are displayed on one or more large screens within the casino environment or at another location such as the Internet. It is an object of the present invention to provide a tournament leader board and winning players to be displayed on any of the gaming devices and online wagering games connected to the gaming system.

It is an object of the present invention for the gaming devices and online wagering games to have the correct mechanism for a player to operate the tournament event from any of the gaming devices or online wagering games. It is a further object of the present invention for the players to play from any device connected to the gaming system.

It is an object of the present invention for the system to be able to verify the person logging in online, to verify that it is that person and that they are of the proper age to be in the system. It is an object of the present invention for each user to apply to become a member of the system, at that the system screen each user for age, criminal record, or any other kind of security before they are given a pass code to play on the system.

It is an object of the present invention that once a user is logged into the system, the user can choose the casino that they wish to be playing in. It is an object of the present invention for the system to have a drop down menu so that the user can choose the casino, the type of game and the type of game they wish to play. It is an object of the present invention for the system to provide a list of the progressive bonuses on the different games, and the user to choose which game with which progressive bonus they wish to play. It is an object of the present invention for the system to notify the user when a progressive bonus has reached a certain amount, and ask if the user wants to join the game.

It is an object of the present invention for the user to be able to see what games his friends are playing in the system.

### BRIEF DESCRIPTION OF THE INVENTION

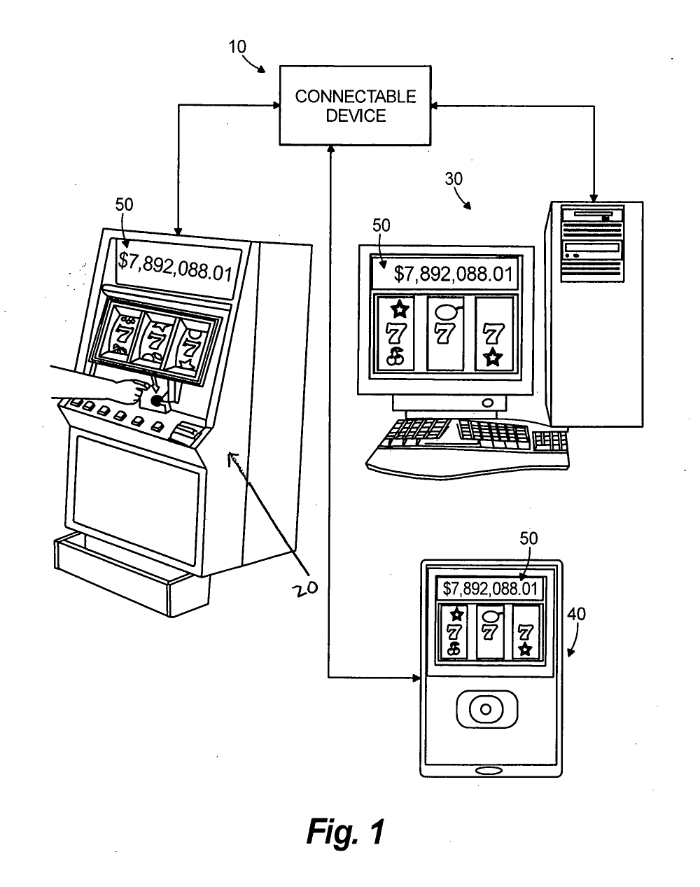

FIG. 1 is an embodiment illustrating the progressive bonus of the present invention shown on a gaming device in a casino environment, a computer for playing of an online wagering game and a mobile device for playing of an online wagering game all connected to a connectable device that controls the gaming system.

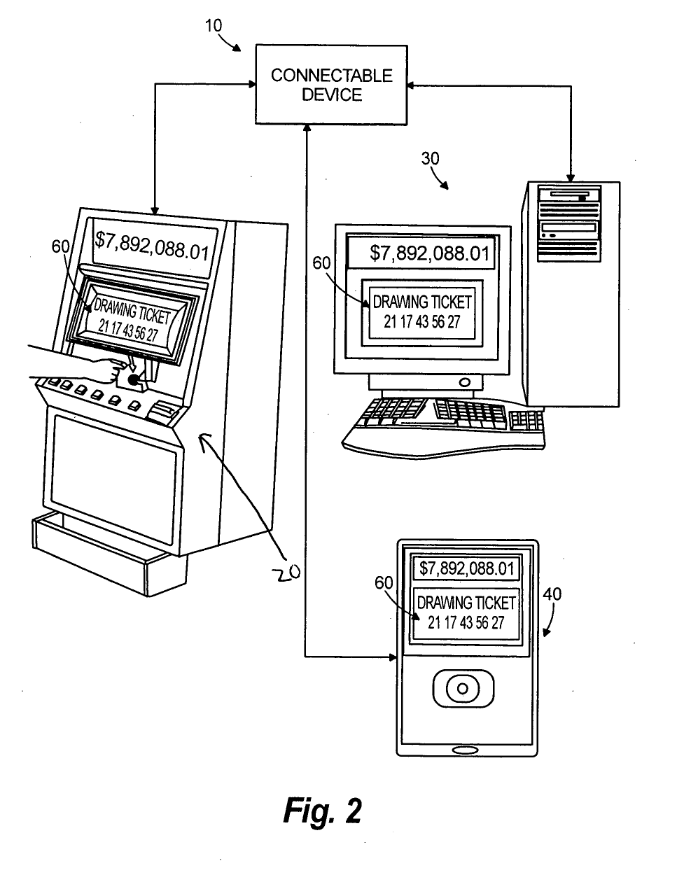

FIG. 2 is an embodiment illustrating an electronic drawing ticket of the present invention that is awarded to any of the gaming device or online wagering game players.

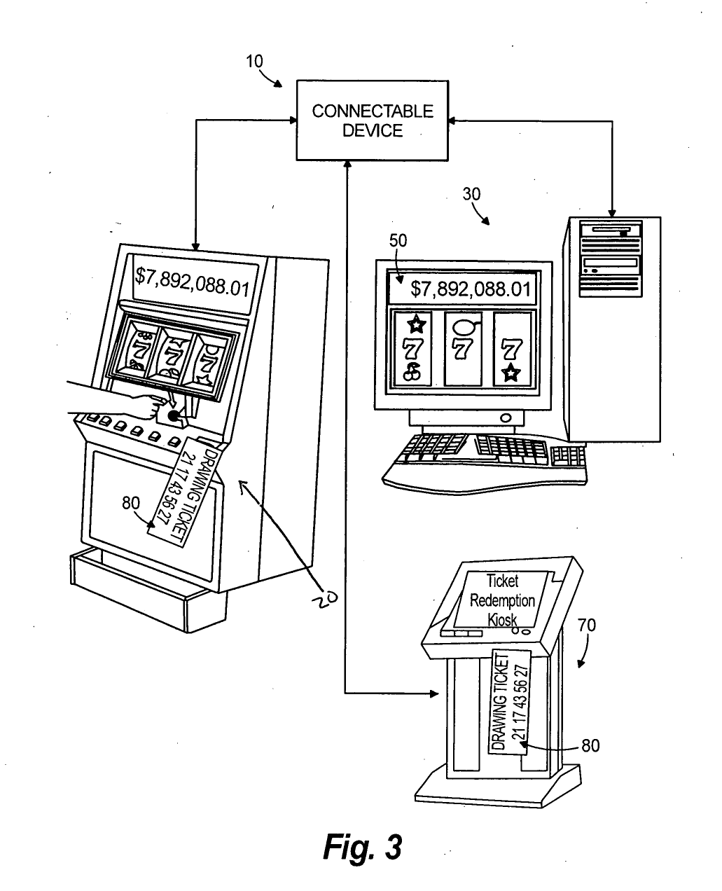

FIG. 3 is an embodiment illustrating a paper drawing ticket of the present invention that is dispensed from the gaming device or dispensed from a kiosk.

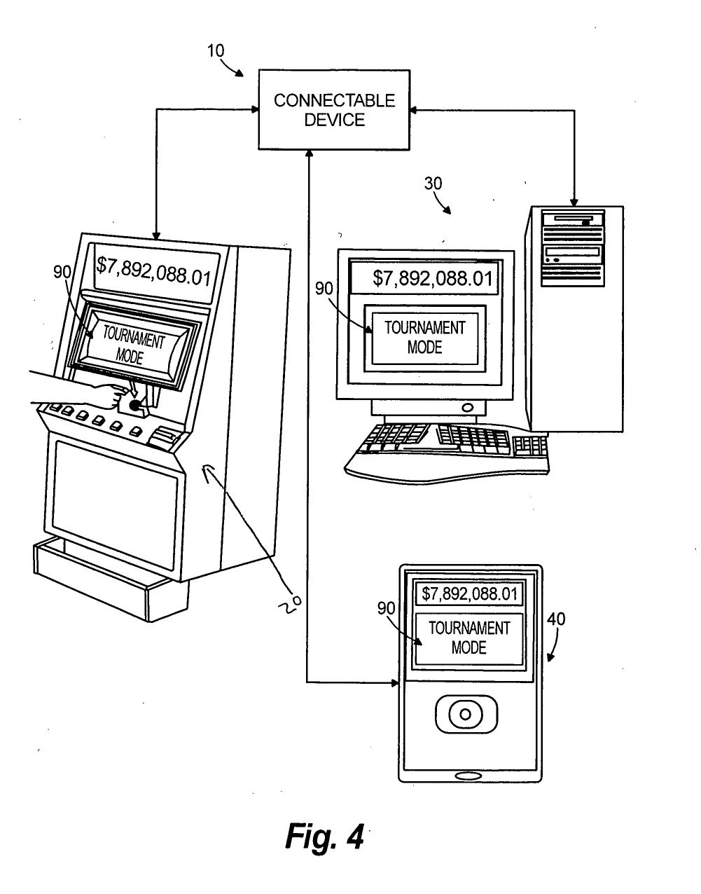

FIG. 4 is an embodiment illustrating a tournament mode of the present invention for any of the gaming device players and online wagering players to participate in a tournament for cash or prizes.

### DETAILED DESCRIPTION OF THE INVENTION

The present invention relates to gaming systems which link to a plurality of gaming devices in a casino environment and to online wagering games played on home computers, laptops, tablets and mobile devices such as cell phones.

In an embodiment, the gaming system comprises a device that alerts the player when the system goes into tournament mode or when a tournament event will begin. In an embodiment, a user to enter his name or other personal information to be identified during the tournament into the system.

In an embodiment, the system sets the tournament to begin instantly or at any time the system chooses. Players can be entered into a tournament based on time played, money wagered, a winning combination while playing the primary game, through an email invitation or they can buy their way into the tournament.

In an embodiment the system offers extra bonus tickets during certain times of the day. This can entice players to play at off peak hours.

In a preferred embodiment, the progressive bonus is funded or tabulated as a fixed percentage or hold from the total dollars wagered on all of the gaming devices and online wagering games connected to the system.

In an embodiment, the present invention provides a method which visually or by audio alerts the player when they have won a progressive bonus, a drawing ticket, or have received entry into a tournament.

In an embodiment, the system of the present invention is progressively linked to offer large jackpots that can include several casino establishments, as well as online play in several states or countries.

In an embodiment, a user has been screened by the system, age, criminal record, etc., and given a pass code to login into the system. The user logs into the system and either chooses from a drop down menu or uses a search engine on the system to find the game that the user wants to play online. The user can view before entering the game the progressive bonuses that are currently part of each game. The user then goes into the game and plays the game and with each play of the game, the progressive bonus increases, if there is no winner. The user can be shown incentives while they are online for playing other games that do not have as large a progressive bonus, such as better odds of winning or less coin play.

FIG. 1 is an embodiment illustrating a gaming device 20 such as a slot machine, a computer 30 showing an online wagering game, and a mobile phone 40 showing an online wagering game all linked to a connectable device 10. The progressive bonus 50 shows an amount of $7,892,088.01 can be won by any players on the gaming devices or any of the players of the online wagering games played via computer 30 or mobile phone 40. In this embodiment, an event occurs that allows any of the players playing games connected to the connectable device 10 to win the progressive bonus 50 of $7,892,088.01. The event triggering the progressive bonus 50 could be a winning combination won on the gaming device or on the online wagering game, or any outcome determined by the gaming system operator.

FIG. 2 is an embodiment illustrating a gaming device 20 such as a slot machine, a computer 30 showing an online wagering game, and a mobile phone 40 showing an online wagering game all linked to a connectable device 10. On the screen it shows an electronic drawing ticket 60 that enters a player into a drawing for cash or prizes. Each ticket will be unique and the ticket numbers will be determined by the gaming system or determined by the system operator. The electronic drawing ticket 60 allows entry into a sweepstakes or lottery type drawing. The drawing tickets can be obtained by either the gaming device player or the player of the online wagering game. The drawing ticket is an electronic ticket 60 that can be stored in the gaming system for a future drawing or an instant drawing.

FIG. 3 is an embodiment illustrating a gaming device 20 such as a slot machine, a computer 30 showing an online wagering game, and a kiosk 70 all linked to a connectable device 10. A mobile device can also be linked to the kiosk 70 through the gaming system. The illustration shows a paper drawing ticket 80 being dispensed by the gaming device and shows a paper drawing ticket 80 being dispensed at a kiosk 70. The gaming system allows for players to store their electronic drawing tickets in a player's account. The players playing the gaming devices or the online wagering games can convert their electronic drawing tickets into paper drawing tickets 80 at the kiosk 70 or at the gaming device 20.

FIG. 4 is an embodiment illustrating a gaming device 20 such as a slot machine, a computer 30 showing an online wagering game, and a mobile phone 40 showing an online wagering game all linked to a connectable device 10 where an online wagering game is played and where the gaming system has entered tournament mode 90. The gaming system allows for tournament participants to control their tournament play at the gaming device 20 or via computer 30, laptop, tablet or mobile device such as a mobile phone 40.

In an embodiment, the gaming device players and the online wagering game players can enter a bonus game. Each player within the gaming system has access to the bonus game and sees the bonus game on the screen of the device they are using. Players can interact with one another and interact in the bonus game. Players can share the prize from the bonus game or compete to see who gets high score during the bonus game to win most or all of the bonus prize. The bonus game can be a multi-player game where each player takes a turn from their own devices connected to the gaming system. The bonus game could be a game such as blackjack or poker where the players connected to the system play against each other for a prize. The bonus game can be a board game such as monopoly where the players play together or against each other for a prize.

1. A gaming machine system comprising a plurality of gaming devices linked to devices facilitating play of online wagering games.

2. The gaming machine system of claim 1 wherein said gaming devices and said devices linking play of online wagering games are linked by a connectable device.

3. The gaming machine system of claim 1 wherein said system pools money from play of said gaming devices and from play of said online wagering games to facilitate a large progressive bonus.

4. The gaming machine system of claim 3 wherein pooling of money of claim is combined to offer same progressive bonus to both gaming device player and online wagering game player.

5. The gaming machine system of claim 1 further comprising said system enters anyone playing either a gaming device or an online wagering game played on a computer or mobile device.

6. The gaming machine system of claim 1 wherein said gaming device comprises any slot machine, video lottery terminal, video poker machine, electronic table game, video bingo or keno machine found in a casino environment.

7. The gaming system of claim 1 wherein said online wagering games comprise online slot machine games, keno games, bingo games, lottery games or games of chance played on a computer, laptop, tablet or mobile device.

8. The gaming system of claim 1 wherein said online wagering games comprise any games of skill such as online poker, video poker, fantasy sports wagering or chess that is played on a computer, laptop, tablet or mobile device.

9. The gaming system of claim 5 further comprising any player of either a gaming device or an online wagering game having a chance to win the progressive bonus.

10. The gaming system of claim 3 wherein said progressive bonus is triggered by any random outcome of any of said gaming devices or online wagering games connected to said gaming machine system.

11. The gaming system of claim 3 wherein said progressive bonus is triggered by any event; whether the event is based on time played, amount wagered, or a winning combination triggered by the gaming device or online wagering game.

12. The gaming machine system of claim 1 further comprising entry into a drawing based on play of any one of said plurality of gaming devices or said online wagering games.

13. The gaming machine system of claim 12 wherein said drawing comprises a specific amount, or for a progressive bonus an amount that grows larger based on play of said plurality of gaming devices and said online wagering games.

14. The gaming machine system of claim 12 wherein said entry is an electronic drawing ticket received during play of any of said gaming devices or online wagering games.

15. The gaming machine system of claim 12 wherein said entry comprises a paper ticket dispensed by said gaming device or a kiosk.

16. The gaming machine system of claim 14 wherein said electronic drawing ticket is stored in a player's account in said gaming machine system.

17. The gaming machine system of claim 14 wherein said electronic drawing ticket is converted to a paper drawing ticket at said gaming device or at a kiosk connected to said gaming machine system

18. The gaming machine system of claim 12 wherein said entry comprises any type of ticket used to hold a drawing; including a raffle ticket, keno ticket, sweepstakes ticket, or lottery ticket.

19. The gaming machine system of claim 1 wherein said system provides entry into a tournament.

20. The gaming machine system of claim 19 wherein said tournament is entered into based on any event; including time played, amount wagered, or a winning combination triggered by said gaming device or online wagering game.

21. The gaming machine system of claim 19 wherein said tournament is for one or more players to participate for cash or prizes.

22. The gaming machine system of claim 19 wherein said tournament is played from any of said plurality gaming devices and online wagering games connected to said gaming machine system.
